(19) United States
(12) Patent Application Publication
(10) Pub. No.: US 2026/0100884 A1
(43) Pub. Date: Apr. 9, 2026

(54) SYSTEM AND METHOD FOR ENABLING RADIO QUALITY ANALYSIS IN COMMUNICATION NETWORKS

(71) Applicant: JIO PLATFORMS LIMITED, Ahmedabad (IN)

(72) Inventors: Aayush BHATNAGAR, Navi Mumbai (IN); Pradeep Kumar BHATNAGAR, Navi Mumbai (IN); Uday SHANBHAG, Mumbai (IN); Hanumant KADAM, Mumbai (IN); Rishi KOUL, New Delhi (IN); Ritesh KUMAR, Gaya (IN); Vivek PATEL, Indore (IN); Chaitanya Reddy POLSONI, Hyderabad (IN)

(73) Assignee: JIO PLATFORMS LIMITED, Ahmedabad (IN)

(21) Appl. No.: 18/992,259

(22) PCT Filed: Jun. 17, 2024
(86) PCT No.: PCT/IN2024/050853

§ 371 Date: Jan. 8, 2025

(30) Foreign Application Priority Data
Jun. 29, 2023 (IN) 202321043761

(51) Int. Cl. H04L 41/14; H04B 17/309; H04W 24/10

(52) U.S. Cl. CPC H04L 41/14; H04B 17/309; H04W 24/10

(57) ABSTRACT

The present disclosure provides system and method for performing radio quality analysis in a communication network (104). The communication network (104) includes a platform (406) that receives a first request to initiate a trace measurement across a plurality of UEs (108) associated with a node (430). In response to the first request, the platform (406) sends a start trace command to the node (430) to obtain measurement data from the plurality of UEs (108). The platform receives a second request to stop the trace measurement across the plurality of UEs (108). In response to the second request, the platform (406) sends a stop trace command to the node (430). The node (430), upon receiving the stop trace command, sends the received measurement data obtained from each of the plurality of UEs (108) to store in a database (218) associated with the communication network (104). The platform (406) analyses the stored measurement data to generate a radio quality report.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF DISCLOSURE

The embodiments of the present disclosure generally relate to communication technology. In particular, the present disclosure relates to a system and method for enabling radio quality analysis in communication networks.

### BACKGROUND OF DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

The telecommunication network is huge and contains millions of cells and thousands of Radio Nodes, managing such a huge network is a very difficult task. By its very nature Radio interface is very complex and dynamic in nature and subject to lot of interference which degrade the network quality and affect the service. Also, there are multiple factors which attenuate the radio signal and affect the service, at times lesser attenuation and more signal which leads to spill over of radio signal in other cell's coverage which is unintended interference to that other cell.

In order to manage a radio network optimally it is needed to be constantly monitored and analysed for signal strength and interferences to adjust radio parameters to reduce the negative effects of interferences and maintain good quality signal without creating interference to other cells.

Management of the network containing millions of cells and thousands of radio nodes is a very difficult task. The radio interface is complex and dynamic in nature which causes lot of interference. This degrades the network quality and affects the service. Further, the service is also affected by multiple factors (e.g., interference, absorption, reflection, etc.) attenuating the radio signals. Sometimes, more signal leads to spill over of the radio signals in other cell's coverage which is an unintended interference to that other cell. In order to manage the radio network optimally, there is need of constant monitoring of signal strengths and interferences. The signals need to be analysed to adjust the radio parameters to reduce the negative effects of interferences and maintain good quality signal without creating interference to other cells.

Currently, the signal strengths are measured at different locations by performing the drive tests. Measurements of signals and interferences are done at different geographical location in the cell boundary. The user equipments (e.g., mobile devices) report measurement data (e.g., UE's signal strengths and also other cells signal strength). The radio node captures the measurement data and performs radio quality analysis using a radio quality trace to find out the anomalies and fix them. But the radio node has to enable the radio traces on the network. This can affect the performance of the node if the node is already serving many subscribers near its capacity. Processing and analysing of the collected traces take lot of time and power due to its large volume.

Conventional systems and methods face difficulty in management of multiple radio nodes in an optimized manner. There is, therefore, a need in the art to provide a method and a system that can overcome the shortcomings of the existing prior arts.

### OBJECTS OF THE PRESENT DISCLOSURE

Some of the objects of the present disclosure, which at least one embodiment herein satisfies are as listed herein below.

An object of the present disclosure is to provide a system and method for enabling radio quality analysis in communication networks.

An object of the present disclosure is to optimizes the network's performance, improving signal strength, coverage, and overall service quality.

An object of the present disclosure is to help in troubleshooting network problems by identifying specific areas or cells that are causing issues. This allows for targeted interventions and faster resolution of network problems, minimizing service disruptions.

An object of the present disclosure is to identify areas with weak coverage or high interference, helping network operator to make informed decisions regarding antenna placement, cell configuration, and network expansion.

An object of the present disclosure is to address network issues, optimize performance, and provide a better user experience thereby retaining existing customers, attract new ones, and improve overall brand reputation.

### SUMMARY

The present disclosure discloses a method for performing radio quality analysis in a communication network. The communication network comprises an entity management system (EMS), a node, and a plurality of user equipments (UEs). The method includes receiving a first request to initiate a trace measurement across the plurality of UEs associated with the node. In response to the first request, the EMS sends a start trace command to the node to obtain measurement reports from the plurality of UEs. Thereafter, the method includes receiving a second request, at the EMS, to stop the trace measurement across the plurality of UEs. In response to the second request, the EMS sends a stop trace command to the node. The node, upon receiving the stop trace command, stores the received measurement reports obtained from each of the plurality of UEs in a database associated with the communication network.

In an embodiment, the first request comprises identity of the node, a time and duration of enabling the traces.

In an embodiment, the method comprises analysing the stored measurement data (e.g., trace record) to generate a measurement report.

In an embodiment, the measurement reports indicate anomalies in the radio quality. In an example, the measurement report is one of a cell-wise report, neighbour wise report, periodic distribution report, periodic overlapping report.

The present disclosure discloses a system for performing radio quality analysis in a communication network. The system comprises a platform (e.g., network management platform), a plurality of element management system (EMSs), a node, and a plurality of user equipments (UEs). The system includes a database to store information pertaining to the plurality of UEs. The platform is configured to manage the plurality of EMSs. Further, the platform includes a processing engine communicatively coupled to the database. The processing engine is configured to receive a first request to initiate a trace measurement across the plurality of UEs associated with the node. In response to the first request, the processing engine may send a start trace command to the node to obtain measurement data from the plurality of UEs. Thereafter, the processing engine may receive a second request to stop the trace measurement across the plurality of UEs. In response to the second request, the processing engine may send a stop trace command to the node. The node, upon receiving the stop trace command, stores the received measurement data obtained from each of the plurality of UEs in the database.

In an embodiment, the first request comprises identifier of the node, a time and duration of enabling the traces.

In an embodiment, the processing engine is further configured to analyse the stored measurement data to generate a measurement report (e.g., radio quality report).

In an embodiment, the report indicates anomalies in the radio quality. In an example, the report is one of a cell-wise report, neighbour wise report, periodic distribution report, periodic overlapping report.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1 illustrates an exemplary architecture 100 for enabling radio quality analysis in communication networks, in accordance with embodiments of the present disclosure.

FIG. 2 illustrates an exemplary micro service-based architecture 200 of the system 102, in accordance with embodiments of the present disclosure.

FIG. 3 illustrates an exemplary architecture 300 connectivity with EMS (Element Management Systems) and nodes for enabling radio quality analysis in communication networks, in accordance with embodiments of the present disclosure.

FIG. 4 illustrates an exemplary workflow diagram 400 for enabling radio quality analysis in communication networks, in accordance with embodiments of the present disclosure.

FIG. 5A illustrates an exemplary sequence diagram 500 for enabling radio quality analysis in communication networks, in accordance with embodiments of the present disclosure.

FIG. 5B is an exemplary flow diagram 500 for performing radio quality analysis in communication networks, in accordance with embodiments of the present disclosure.

FIGS. 6A-6C illustrate an exemplary user interface 600 representing radio quality analysis, in accordance with embodiments of the present disclosure.

FIG. 7 illustrates an exemplary computer system 700 in which or with which embodiments of the present disclosure may be implemented.

The foregoing shall be more apparent from the following more detailed description of the disclosure.

### LIST OF REFERENCE NUMERALS

100 Network architecture
102 System
104 Network
106 Centralized Server
108-1 Computing Device/User Equipment (UE)
108-2 Computing Device/User Equipment (UE)
108-3 Computing Device/User Equipment (UE)
110-1 User
110-2 User
110-3 User
112 Node
200 Micro service-based architecture
201 Platform
202 Processor
204 Memory
208 Processing Engine
210 Data Acquisition Module
212 Micro Service Module
214 Change Management Module
216 Other Modules
218 Database
300 Exemplary Architecture
302 User Plane
304 Application User
306 Application User
308 Analytics Engine
310 Scheduler
312 Change Management Engine
314 Query Engine and Reporting Engine
316 Micro Service
318 Business Rules Settings
320 Vendor Library
322 CMBD
324 History
326 Configuration
328 Load Balancing Plane
330 Nodes
332 EMS
334 Multi-Vendor/Version Support
400 Exemplary Workflow Diagram
402 Server
404 Element Management System
406 Network Management Platform
430 Node
500 Exemplary Sequence Diagram
501 Step
502 EMS
504 Step
506 Step
508 Step
510 Step
512 Step
514 Step
516 Step
550 Flow Diagram
552 Step
554 Step
556 Step
558 Step
560 Step
600 Exemplary User Interface
650 RQA Scheduling Work Order
660 Periodic Distribution
700 Computer System
710 External Storage Device
720 Bus
730 Main Memory
740 Read-Only Memory
750 Mass Storage Device
760 Communication Port(s)
770 Processor

### DETAILED DESCRIPTION OF DISCLOSURE

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure relates to measuring the signal strength at different locations where normally drive tests are performed. The signal and interference measurements are done at different geographical location in the cell boundary. In addition, different user equipments or mobile devices are configured to report signal strengths of a primary cell and neighboring cells. Using a radio quality trace from the radio node, various signal measurements and radio quality analysis are performed to identify various anomalies. Enabling the radio traces on the network is not a routine task for the node and can affect the performance of the node, when node is serving many subscribers or when the node is near its maximum capacity. Also, the collected traces are bulky files which take a lot of computing power for processing and analysing.

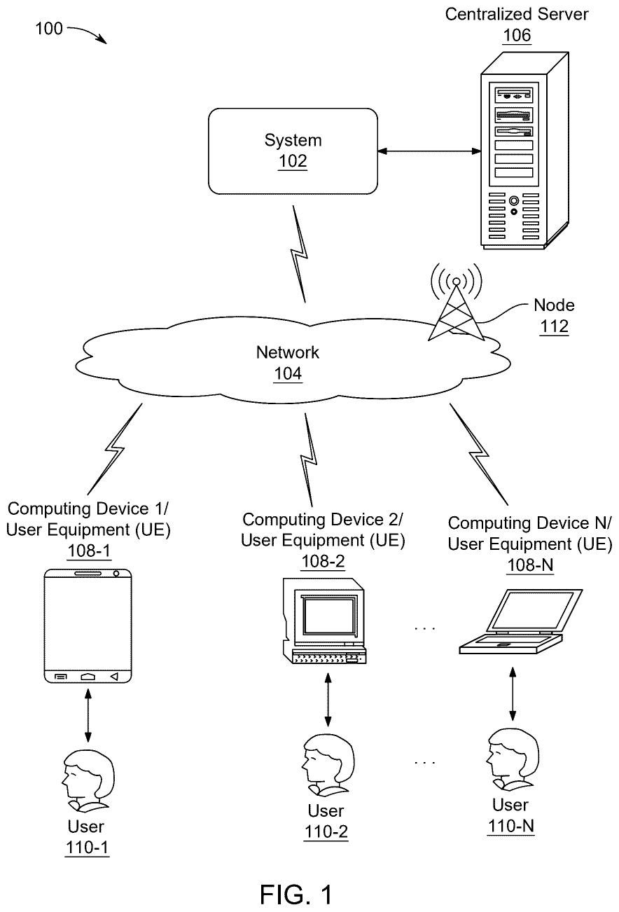

The various embodiments throughout the disclosure will be explained in more detail with reference to FIGS. 1-7.

FIG. 1 illustrates an exemplary architecture 100 for enabling radio quality analysis in communication networks, in accordance with embodiments of the present disclosure.

Referring to FIG. 1 the architecture 100 is implemented for enabling radio quality analysis in communication networks.

In an embodiment, the system 102 will be connected to a network 104, which is further connected to at least one computing devices 108-1, 108-2, . . . 108-N (collectively referred as computing device 108, herein) associated with one or more user devices 110-1, 110-2, . . . 110-N (collectively referred as computing device 110, herein). The computing device 108 may be personal computers, laptops, tablets, wristwatch or any custom-built computing device integrated within a modern diagnostic machine that can connect to a network as an IoT (Internet of Things) device. Further, the network 104 can be configured with a centralized server 106 that stores compiled data.

In an embodiment, the system 102 may receive at least one input data from the at least one computing devices 108. A person of ordinary skill in the art will understand that the at least one computing devices 108 may be individually referred to as computing device 108 and collectively referred to as computing devices 108. In an embodiment, the computing device 110 may also be referred to as User Equipment (UE). Accordingly, the terms “computing device” and “User Equipment” may be used interchangeably throughout the disclosure.

In an embodiment, the computing device 108 may transmit the at least one captured data packet over a point-to-point or point-to-multipoint communication channel or network 104 to the system 102.

In an embodiment, the computing device 108 may involve collection, analysis, and sharing of data received from the system 102 via the communication network 104.

In an exemplary embodiment, the communication network 104 may include, but not be limited to, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. In an exemplary embodiment, the communication network 104 may include, but not be limited to, a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In this aspect, the system may be embedded with 4G, 5G, or 6G technology. The system has the capability to be seamlessly integrated with a variety of other networking concepts. This includes but is not limited to, protocols like HTTP, TCP/IP, FTP, and DNS. Additionally, the system can also be configured to work with different network topologies, such as star, mesh, bus, and ring, providing flexibility and adaptability to the user's needs. This integration with other networking concepts allows for a more versatile and dynamic system, capable of meeting the requirements of various network environments.

In an embodiment, the one or more computing devices 108 may communicate with the system 102 via a set of executable instructions residing on any operating system. In an embodiment, the one or more computing devices 108 may include, but not be limited to, any electrical, electronic, electro-mechanical, or an equipment, or a combination of one or more of the above devices such as mobile phone, smartphone, Virtual Reality (VR) devices, Augmented Reality (AR) devices, laptop, a general-purpose computer, desktop, personal digital assistant, tablet computer, mainframe computer, or any other computing device, wherein the one or more computing devices 108 may include one or more in-built or externally coupled accessories including, but not limited to, a visual aid device such as camera, audio aid, a microphone, a keyboard, input devices such as touch pad, touch enabled screen, electronic pen, receiving devices for receiving any audio or visual signal in any range of frequencies, and transmitting devices that can transmit any audio or visual signal in any range of frequencies. It may be appreciated that the one or more computing devices 108 may not be restricted to the mentioned devices and various other devices may be used.

A layout of the output end of the system 102 is described, as it may be implemented. The output of this system 102 is managing a radio network optimally which is needed to be constantly monitored and analysed for signal strength and interferences to adjust radio parameters to reduce the negative effects of interferences and maintain good quality signal without creating interference to other cells.

In an embodiment, the system is connected to a network 104, which is connected to the at least one computing device 110 may include but not limited to personal computers, smartphones, laptops, tablets, smart watches as well as other IoT devices that support a display.

In an embodiment, the network 104 is further configured with a centralized server 106 including a database, where all output is stored as part of records. It can be retrieved whenever there is a need to reference this output in future.

In an embodiment, the computing device 108 associated with the one or more user 110 may transmit the at least one captured data packet over a point-to-point or point-to-multipoint communication channel or network 104 to the system 102.

In an embodiment, the computing device 108 may involve collection, analysis, and sharing of data received from the system 102 via the communication network 104. A node 112 may be a base station in the network architecture 100.

Although FIG. 1 shows exemplary components of the network architecture 100, in other embodiments, the network architecture 100 may include fewer components, different components, differently arranged components, or additional functional components than depicted in FIG. 1. Additionally, or alternatively, one or more components of the network architecture 100 may perform functions described as being performed by one or more other components of the network architecture 100.

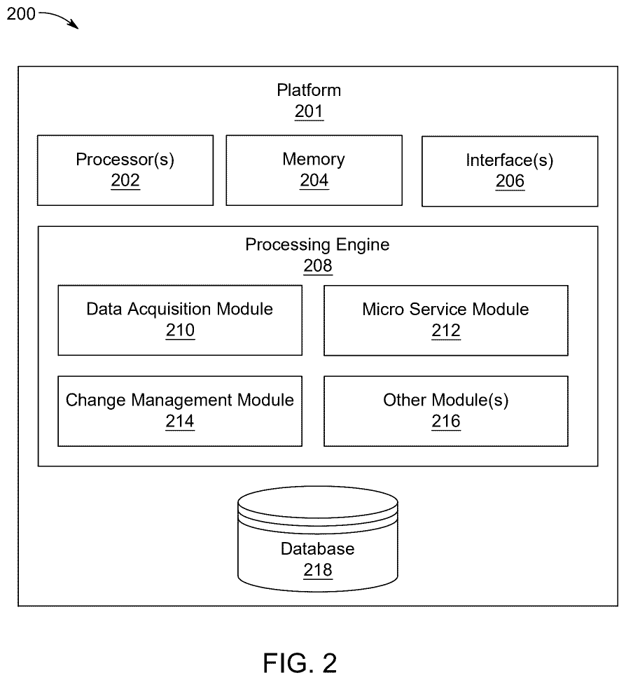

FIG. 2 illustrates an exemplary micro service-based architecture 200 of the system 102, in accordance with embodiments of the present disclosure.

In an example, the system 102 may be a network management platform. The disclosed micro service-based architecture 200 that ensures selection of suitable and optimized radio node for serving UE as per the service requirement scope. The architecture 200 comprises a platform (e.g., network management platform) 201.

FIG. 2 with reference to FIG. 1, illustrates the platform 201 for enabling radio quality analysis (RQA) in communication networks, in accordance with an embodiment of the present disclosure.

In an aspect, the platform 201 may comprise one or more processor(s) 202. The one or more processor(s) 202 may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) 202 may be configured to fetch and execute computer-readable instructions stored in a memory 204 of the platform 201. The memory 204 may be configured to store one or more computer-readable instructions or routines in a non-transitory computer readable storage medium, which may be fetched and executed to create or share data packets over a network service. The memory 204 may comprise any non-transitory storage device including, for example, volatile memory such as Random Access Memory (RAM), or non-volatile memory such as Erasable Programmable Read-Only Memory (EPROM), flash memory, and the like.

Referring to FIG. 2, the platform 201 may include an interface(s) 206. The interface(s) 206 may comprise a variety of interfaces, for example, interfaces for data input and output devices, referred to as I/O devices, storage devices, and the like. The interface(s) 206 may facilitate communication to/from the platform 201. The interface(s) 206 may also provide a communication pathway for one or more components of the platform 201. Examples of such components include, but are not limited to, processing unit/engine(s) 208 and a local database 218.

In an embodiment, the processing unit/engine(s) 208 may be implemented as a combination of hardware and programming (for example, programmable instructions) to implement one or more functionalities of the processing engine(s) 208. In examples described herein, such combinations of hardware and programming may be implemented in several different ways. For example, the programming for the processing engine(s) 208 may be processor-executable instructions stored on a non-transitory machine-readable storage medium and the hardware for the processing engine(s) 208 may comprise a processing resource (for example, one or more processors), to execute such instructions. In the present examples, the machine-readable storage medium may store instructions that, when executed by the processing resource, implement the processing engine(s) 208. In such examples, the platform 201 may comprise the machine-readable storage medium storing the instructions and the processing resource to execute the instructions, or the machine-readable storage medium may be separate but accessible to the platform 201 and the processing resource. In other examples, the processing engine(s) 208 may be implemented by electronic circuitry.

In an embodiment, the database 218 may comprise data that may be either stored or generated as a result of functionalities implemented by any of the components of the processor 202 or the processing engines 208. In an embodiment, the local database 218 may be separate from the platform 201.

In an exemplary embodiment, the processing engine 208 may include one or more engines selected from any of a data acquisition module 210, a micro service module 212, a change management module 214, and other modules 216 having functions that may include but are not limited to testing, storage, and peripheral functions, such as wireless communication unit for remote operation, audio unit for alerts and the like.

The processing engine 208 is configured to receive a first request to initiate a trace measurement across the plurality of UEs associated with the node. The first request may be raised by an administrator. In an embodiment, the first request comprises identifier of the node, a time and duration of enabling the traces. In response to the first request, the processing engine 208 may send a start trace command to the node to obtain measurement data from the plurality of UEs. The trace command may refer to a radio quality trace which is a detailed log or record, or measurement data of various signal metrics related to the quality of the radio signal in a wireless communication system.

In response to the first request, the processing engine 208 is configured to communicate the start trace command to a node (for example, node 112). In response to the start trace command, the node (112) obtains measurement data from the plurality of UEs (108-1, 108-2. 108-N) associated with the node (112) along with corresponding locations of the plurality of UEs (108-1, 108-2. 108-N). The measurement report may include a received signal strength indicator (RSSI), a signal to noise ratio (SNR), a bit error rate (BER), a channel quality indicator (CQI), propagation delay, a packet loss rate, interference levels, and channel conditions.

Thereafter, the processing engine 208 may receive a second request to stop the trace measurement across the plurality of UEs. In response to the second request, the processing engine 208 may send a stop trace command to the node (112). The node (112), upon receiving the stop trace command, stores the received measurement data obtained from each of the plurality of UEs (108-1, 108-2 . . . 108-N) in a storage (for example, storage of server 106 or local database 218).

Data acquisition module 210 may access the measurement data from the storage for radio quality analysis. The micro service module 212 may analyse the stored measurement data to generate a radio quality report. The radio quality report may, inter alia, include indications of anomalies in the radio quality. In an example, the report may be a cell-wise report, neighbour wise report, periodic distribution report, and/or periodic overlapping report. Anomaly may refer to undesired signal issues, such as poor signal quality, signal strength lesser than a desired threshold, etc. Based on the radio quality report, the change management module 214 may roll out work orders based on planning, to implement, and controlling changes to the node (112) and related infrastructure to resolve anomalies in a way that minimizes disruption to operations and ensures the successful adoption of changes. Other module(s) (216) may include EMS functions that performs various EMS functions in addition to supporting the analysis of radio quality.

In an alternative embodiment, the EMS is configured to perform radio quality analysis in a communication network.

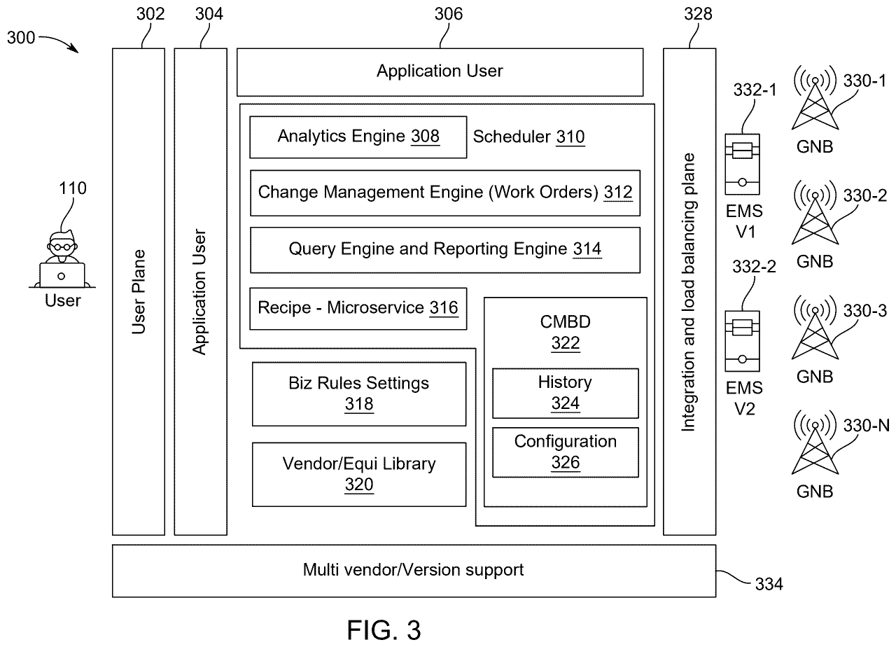

FIG. 3 illustrates an exemplary architecture 300 connectivity with the platform (201) of the FIG. 2, a plurality of EMSs (Element Management Systems) and a plurality of nodes for enabling radio quality analysis in communication networks, in accordance with embodiments of the present disclosure.

In an embodiment, the architecture 300 includes connectivity with the platform (201) and the EMSs, which then are connected to the nodes. For example, the architecture 300 includes user plane 302 as a front end, an application user layer 304, an application user layer 306, and a scheduler 310, that includes an analytics engine 308, change management engine 312, query engine and reporting engine 314, a recipe-micro service 316 and a configuration management database (CMBD) 322. The CMBD includes history 324 and configuration 326. In some examples, there may be business rules settings 318 and vendor library 320. To be able to manage information and data of vendors, there may be multi vendor/version support 334. The scheduler 310 may be interfaced with EMSs (332-1,332-2) and nodes (330-1-N) through an integration and load balancing plane 328. The nodes (330) may be nodeB, enodeB, gNB,

The scheduler 310 may schedule events corresponding to initiating and stopping a trace measurement based on the first request and the second request, respectively. The analytics engine 308 associated with the micro service is configured to schedule analysis of the obtained measurement reports. The analytics engine 308 configured to perform analysis of the obtained measurement data and generate a measurement report (e.g., radio quality report), which could be used for recipe for fixing anomalies. The query engine and reporting engine 314 is configured to process query and generate corresponding responses associated with the measurement reports. The micro service 316 may be configured to provide an access to data from various sources. The CMBD 322 is configured for change management. The integration and load balancing plane 328 interfaces with EMSs (332-1-N) for integrating the scheduler 310 with EMSs (332-1-N) and nodes (330-1-N), The architecture 300 includes server and data bases which contains vendor libraries and storage systems like file storage servers. The system also includes a user interface for the network administrator to provide input on the identity of the node, the time and duration for which the traces have to be enabled on the node.

In an aspect, the plurality of EMSs is configured to manage the plurality of nodes. For example, the nodes (330-1, 330-2) correspond to the EMS (332-1) and the node (330-3) correspond to the EMSs (332-2). The EMSs may send command (e.g., start trace command, stop trace command, etc.) to one of the plurality of nodes based on the node identifier (e.g. SAP ID). Further, each of the nodes and the EMSs are of different original equipment manufacturers (OEMs). Because of the different OEMs, the commands for each of the nodes and the EMSs are different. The commands for each of the nodes and the EMSs are obtained from the vendor library. The vendor library comprises command syntax, identifiers, and parameters.

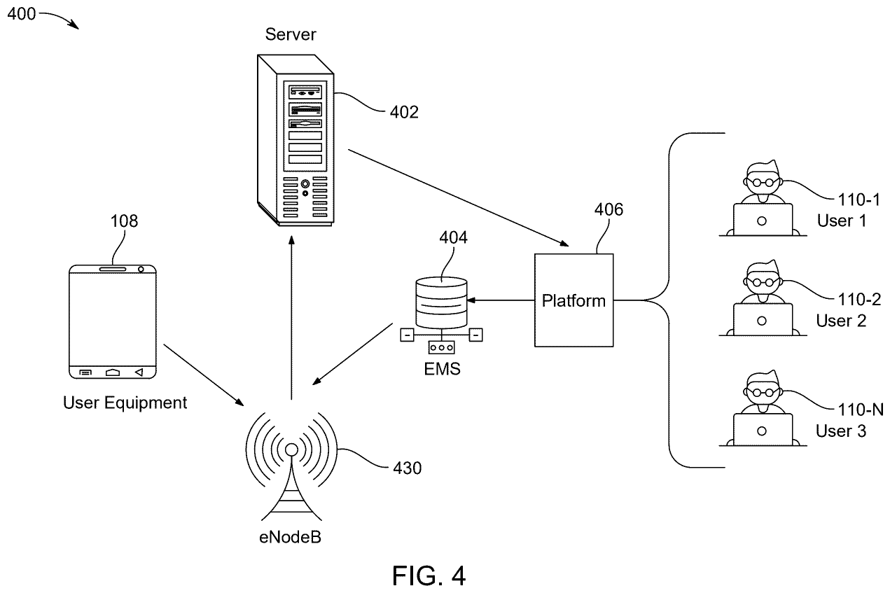

FIG. 4 illustrates an exemplary workflow diagram 400 for enabling radio quality analysis in communication networks, in accordance with embodiments of the present disclosure.

A user equipment (UE) (108) is continuously sending measurement data to a node (e.g., eNodeB) (430). One of users (e.g., administrator) (110-1, 110-2 . . . 110-N) may send a start trace request to a platform (406). The start trace request may comprise an identifier of node, time and duration of enabling the trace. The platform (406) may send the received trace request to the node (430) via an element management system (404). The node (430) may send the measurement data received from the UE (108) to a server (402) to store. The platform (406) may send a stop trace request to the node via the EMS (404) after completion of the duration of the trace received in the trace request. The measurement data is analysed by the platform (406). A measurement report is generated.

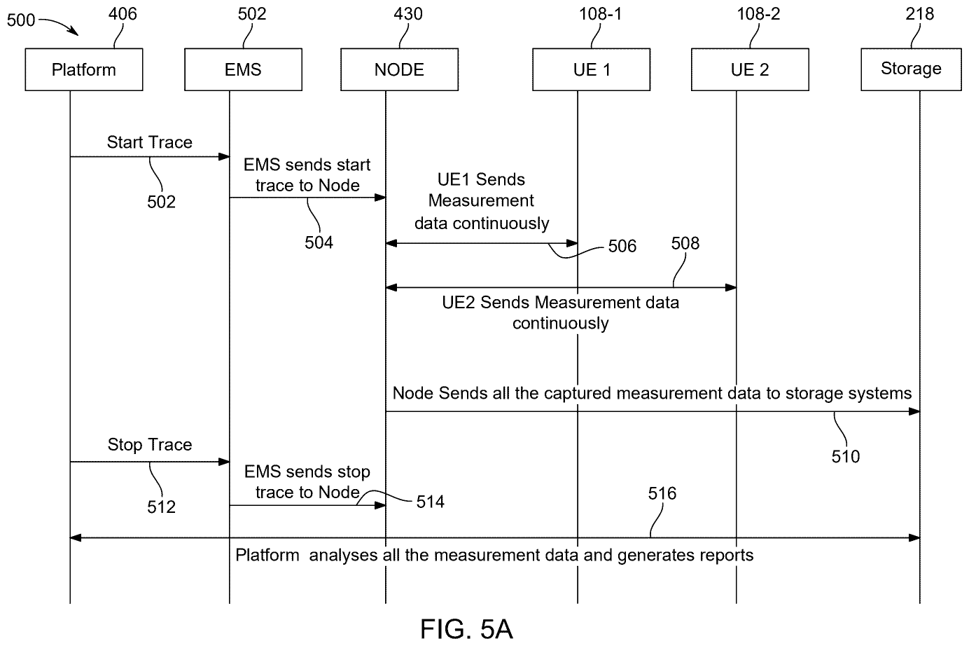

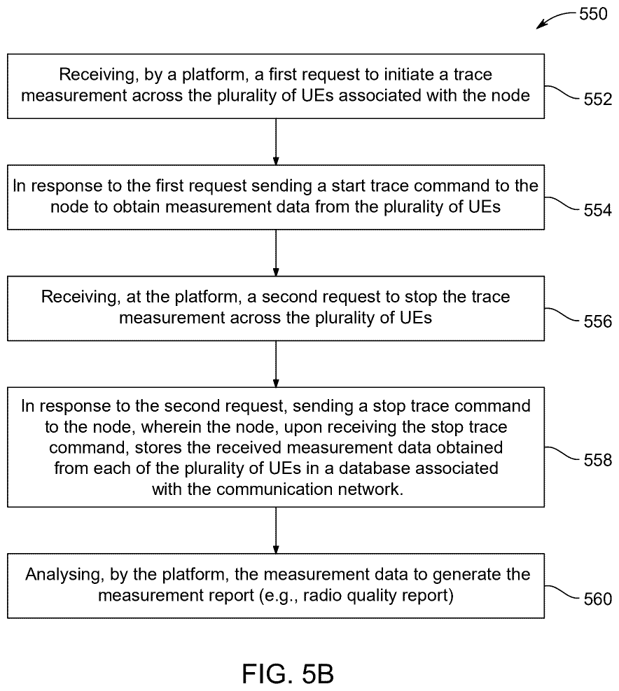

FIG. 5A illustrates an exemplary sequence diagram 500 for enabling radio quality analysis in communication networks, in accordance with embodiments of the present disclosure.

The communication network comprises a platform (406), an entity management system (EMS) (502), a node (430), a plurality of user equipments (UEs) (108-1, 108-2) and a storage (218).

At step 502, the platform 406 may send a start trace request to the EMS (502). The trace request comprises an identifier of node, time and duration of enabling trace.

At step 504, the EMS may select one of the plurality of nodes based on the node identifier provided in the trace request. The EMS 502 may send the start trace request to the node 430.

At step 506, the UE 108-1 continuously sends measurement data to the node 430.

At step 508, the UE 108-2 continuously sends measurement data to the node 430.

At step 510, on receiving the trace request, the node 430 may send all the measurement data to the storage 218.

At step 512, the platform 406 may send a stop trace request to the EMS 502.

At step 514, the EMS 502 may send the received stop trace request to the node 430.

At step 516, the platform 406 may analyse all the measurement data and generate a measurement report (e.g., radio quality report).

Once all the measurement reports are stored in the database, the network management platform analyses the stored measurement reports to generate a radio quality report (also referred to as ‘report’). In an embodiment, the report indicates anomalies in the radio quality. In an example, the report is one of a cell-wise report, neighbour wise report, periodic distribution report, periodic overlapping report.

FIG. 5B illustrates an exemplary sequence diagram 550 for enabling radio quality analysis in communication networks, in accordance with embodiments of the present disclosure.

Step 552 includes receiving, by the platform (406), a first request to initiate a trace measurement across the plurality of UEs (108-1, 108-2 . . . , 108-N) associated with the node (430).

Step 554 includes in response to the first request, sending, by the platform (406), a start trace command to the node. In response to the start trace command, obtaining, at the node, the measurement data from the plurality of UEs (108-1, 108-2 . . . , 108-N) associated with the node (430).

Step 556 includes receiving, at the platform (406), a second request to stop the trace measurement across the plurality of UEs (108-1, 108-2 . . . , 108-N).

Step 558 includes in response to the second request, sending, by the platform (406), a stop trace command to the node (430). The node (430), upon receiving the stop trace command, stores the received measurement data obtained from each of the plurality of UEs (108-1, 108-2 . . . , 108-N) in a database (218) associated with the communication network (104).

Step 560 includes analysing, by the platform (406), the measurement data to generate a measurement report (e.g., radio quality report).

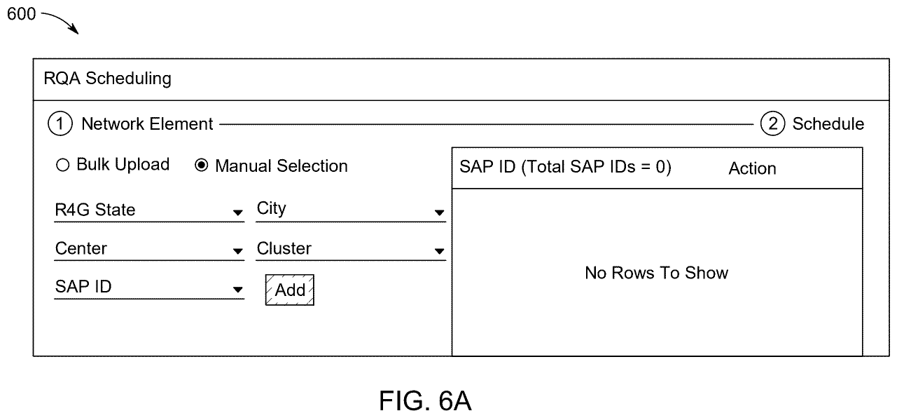

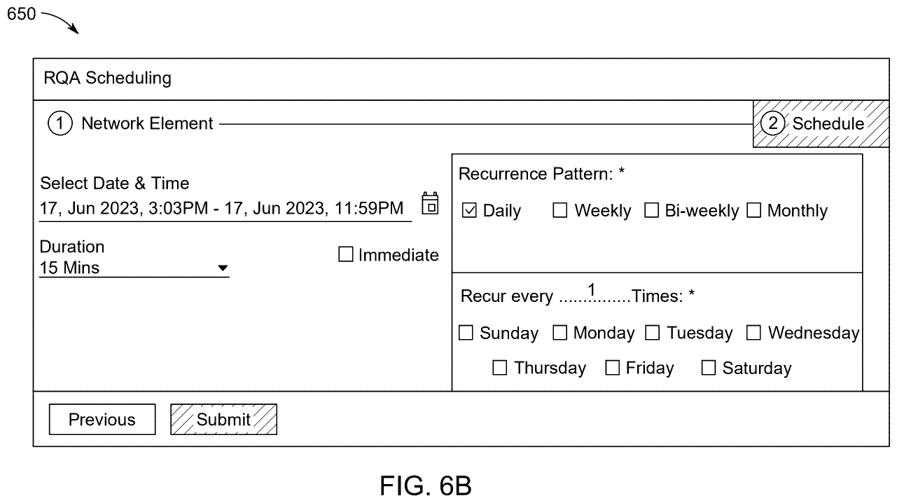

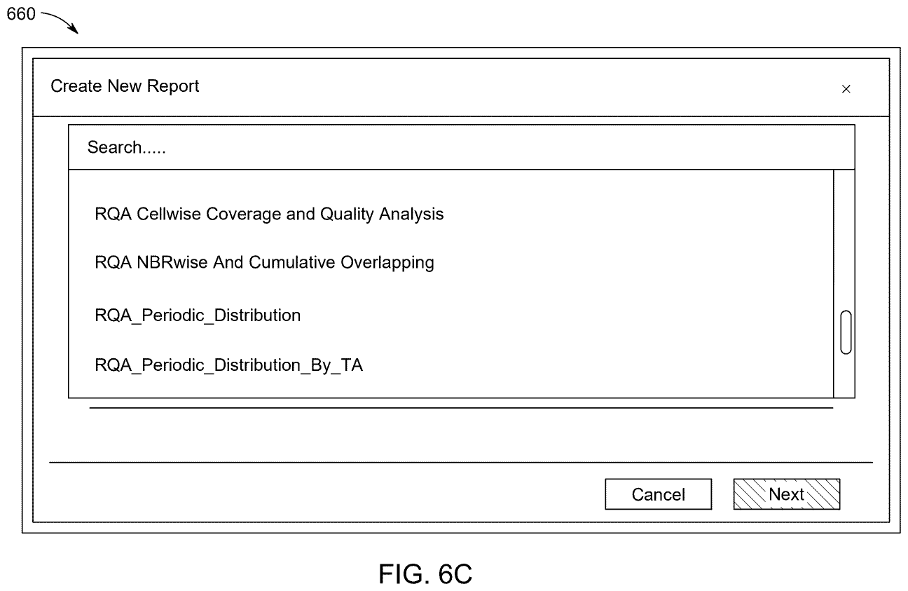

FIGS. 6A-6C illustrates an exemplary user interface 600 representing radio quality analysis, in accordance with embodiments of the present disclosure.

In an embodiment, FIGS. 6A-6C disclosed user interface 600 representing radio quality analysis (RQA). UI screen to create a RQA scheduling work order (650). Types of reports generated through analysis of radio quality traces are RQA CellWise, RQA NeighborWise, Periodic Distribution, Periodic Overlapping, Periodic Distribution (660).

In FIG. 6A, the user interface (UI) 600 represents RQA scheduling performed by the scheduler 310. The user (e.g., administrator) may input data (e.g., SAP ID for particular node, geographical location (e.g., state, city), center, cluster using drop-down option on the UI. There are two options (e.g., bulk upload, manual selection). After inputting the data on UI, the user may click on schedule option provided on the UI.

In FIG. 6B, the user interface (UI) 650 represents RQA scheduling workorder. The user may input data (e.g., date, time, duration, recurrence pattern, recurring numbers, days of week) on the UI 650. The recurrence pattern may comprise daily, weekly, bi-weekly, monthly. There is “immediate” option also provided on the UI. After inputting data, the user can select “submit” option. The change management engine 312 may create a RQA scheduling workorder for the user input data.

In FIG. 6C, the user interface (UI) 660 represents “create new report” in the RQA scheduling. The search option provides report options (such as RQA cellwise coverage and quality analysis, RQA_NBRwise And Cumulative Overlapping, RQA_Periodic_Distribution, RQA_Periodic_Distribution_By_TA). The report types are generated by the analytics engine (308) and the reporting engine (314). After the measurement data is collected from all nodes via storage (218). The report is selected from the UI, and selected report is generated by analysing the received data.

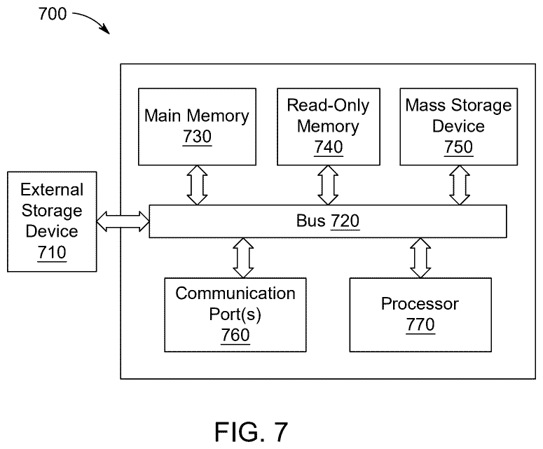

FIG. 7 illustrates an exemplary computer system 700 in which or with which embodiments of the present disclosure may be implemented.

As shown in FIG. 7, the computer system 700 may include an external storage device 710, a bus 720, a main memory 730, a read-only memory 740, a mass storage device 750, communication port(s) 760, and a processor 770. A person skilled in the art will appreciate that the computer system 700 may include more than one processor and communication ports. The processor 770 may include various modules associated with embodiments of the present disclosure. The communication port(s) 760 may be any of an RS- 232 port for use with a modem-based dialup connection, a 10/100 Ethernet port, a Gigabit or 10 Gigabit port using copper or fiber, a serial port, a parallel port, or other existing or future ports. The communication port(s) 760 may be chosen depending on a network, such a Local Area Network (LAN), Wide Area Network (WAN), or any network to which the computer system 700 connects. The main memory 730 may be random access memory (RAM), or any other dynamic storage device commonly known in the art. The read-only memory 740 may be any static storage device(s) including, but not limited to, a Programmable Read Only Memory (PROM) chips for storing static information e.g., start-up or basic input/output system (BIOS) instructions for the processor 770. The mass storage device 750 may be any current or future mass storage solution, which may be used to store information and/or instructions.

The bus 720 communicatively couples the processor 770 with the other memory, storage, and communication blocks. The bus 720 can be, e.g. a Peripheral Component Interconnect (PCI) / PCI Extended (PCI-X) bus, Small Computer System Interface (SCSI), universal serial bus (USB), or the like, for connecting expansion cards, drives, and other subsystems as well as other buses, such a front side bus (FSB), which connects the processor 770 to the computer system.

Optionally, operator and administrative interfaces, e.g. a display, keyboard, and a cursor control device, may also be coupled to the bus 720 to support direct operator interaction with the computer system 700. Other operator and administrative interfaces may be provided through network connections connected through the communication port(s) 760. In no way should the aforementioned exemplary computer system 700 limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

### ADVANTAGES OF THE PRESENT DISCLOSURE

The present disclosure provides a system and method for enabling radio quality analysis in communication networks.

The present disclosure optimizes the network's performance, improving signal strength, coverage, and overall service quality.

The present disclosure helps in troubleshooting network problems by identifying specific areas or cells that are causing issues. This allows for targeted interventions and faster resolution of network problems, minimizing service disruptions.

The present disclosure identifies areas with weak coverage or high interference, helping you make informed decisions regarding antenna placement, cell configuration, and network expansion.

The present disclosure addresses network issues, optimizing performance, and providing a better user experience, you can retain existing customers, attract new ones, and improve overall brand reputation.

1. A method for performing radio quality analysis in a communication network (104), the communication network (104) comprising a platform (406), a node (430), and a plurality of user equipments (UEs) (108), the method comprising:
receiving, at the platform (406), a first request to initiate a trace measurement across the plurality of UEs (108) associated with the node (430);
in response to the first request, sending, by the platform (406), a start trace command to the node (430);
in response to the start trace command, obtaining, at the node (430), the measurement data from the plurality of UEs (108) associated with the node (430);
receiving, at the platform (406), a second request to stop the trace measurement across the plurality of UEs (108); and
in response to the second request, sending, by the platform (406), a stop trace command to the node (430), wherein the node (430), upon receiving the stop trace command, configured to send the received measurement data obtained from each of the plurality of UEs (108) to store in a database (218) associated with the communication network (104).

2. The method as claimed in claim 1, wherein the first request comprises identifier of the node, a time and duration of enabling the traces, wherein the identifier comprises a systems applications and products (SAP) identifier.

3. The method as claimed in claim 1, further comprising analysing, by the platform (406) the stored measurement data to generate a radio quality report.

4. The method as claimed in claim 3, wherein the radio quality report indicates anomalies in the radio quality.

5. The method as claimed in claim 3, wherein the report is one of a cell-wise report, neighbour wise report, periodic distribution report, periodic overlapping report.

6. The method as claimed in claim 1, wherein the measurement reports comprise a received signal strength indicator (RSSI), a signal to noise ratio (SNR), a bit error rate (BER), a packet loss rate, interference levels, and channel conditions.

7. A system (102) for performing radio quality analysis in a communication network (104), the communication network (104) comprising a platform (406), a node (430), and a plurality of user equipments (UEs) (108), the system (102) comprising:
the platform (406) comprising a processing engine (208) communicatively coupled to a database (218), the processing engine (208) is configured to receive a first request to initiate a trace measurement across the plurality of UEs (108) associated with the node (430);
in response to the first request, the processing engine (208) is configured to send a start trace command to the node (430);
in response to the start trace command, the node (430) configured to receive the measurement data from the plurality of UEs (108) associated with the node (430);
the processing engine (208) configured to receive a second request to stop the trace measurement across the plurality of UEs (108); and
in response to the second request, the processing engine (208) is configured to send a stop trace command to the node (430); and
the node (430) configured to send the received measurement data obtained from each of the plurality of UEs (108) to store in the database (218), upon receiving the stop trace command.

8. The system (102) as claimed in claim 7, wherein the first request comprises identifier of the node, a time and duration of enabling the traces, wherein the identifier comprises a systems applications and products (SAP) identifier.

9. The system (102) as claimed in claim 7, wherein the processing engine (208) is further configured to analyse the stored measurement data to generate a radio quality report.

10. The system (102) as claimed in claim 9, wherein the radio quality report indicates anomalies in the radio quality.

11. The system (102) as claimed in claim 9, wherein the report is one of a cell-wise report, neighbour wise report, periodic distribution report, periodic overlapping report.

12. The system (102) as claimed in claim 7, wherein the measurement reports comprise a Received Signal Strength Indicator (RSSI), a Signal to Noise Ratio (SNR), a Bit Error Rate (BER), a packet loss rate, interference levels and channel conditions.

13. A user equipment (108) communicatively connected with a node (430) for communication, the communication comprises at least in part:
communicating measurement reports to a node (430), wherein the measurement reports comprise a received signal strength indicator (RSSI), a signal to noise ratio (SNR), a bit error rate (BER), a packet loss rate, interference levels and channel conditions, wherein the node (430) is communicatively coupled to a platform (406), wherein the platform (406) is configured to perform a method for performing radio quality analysis in a communication network (104) as claimed in claim 1.

14. A computer program product comprising a non-transitory computer-readable medium comprising instructions that, when executed by one or more processors, cause the one or more processors to perform a method for performing radio quality analysis in a communication network (104), the communication network (104) comprising a platform (406), a node (430), and a plurality of user equipments (UEs) (108), the method comprising:
receiving, at the platform (406), a first request to initiate a trace measurement across the plurality of UEs (108) associated with the node (430);
in response to the first request, sending, by the platform (406), a start trace command to the node (430);
in response to the start trace command, obtaining, at the node (430), the measurement data from the plurality of UEs (108) associated with the node (430);
receiving, at the platform (406), a second request to stop the trace measurement across the plurality of UEs (108); and
in response to the second request, sending, by the platform (406), a stop trace command to the node (430), wherein the node (430), upon receiving the stop trace command, configured to send the received measurement data obtained from each of the plurality of UEs (108) to store in a database (218) associated with the communication network (104).
